(19) United States
(12) Patent Application Publication
(10) Pub. No.: US 2024/0037164 A1
(43) Pub. Date: Feb. 1, 2024

(54) WEBPAGE DISPLAY METHOD, SYSTEM AND MEDIUM

(71) Applicant: INSPUR SUZHOU INTELLIGENT TECHNOLOGY CO., LTD., Suzhou, Jiangsu (CN)

(72) Inventor: Kai WANG, Jinan, Shandong (CN)

(21) Appl. No.: 18/020,614

(22) PCT Filed: Sep. 29, 2021
(86) PCT No.: PCT/CN2021/121869

§ 371 Date: Feb. 9, 2023

(30) Foreign Application Priority Data
Dec. 20, 2020 (CN) 202011512796.0

(51) Int. Cl. G06F 16/955; G06F 16/957; G06F 3/0482

(52) U.S. Cl. CPC G06F 16/955; G06F 16/957; G06F 3/0482; G06F 2203/04803

(57) ABSTRACT

A webpage display method, including: monitoring loading conditions of a display area of a home page, performing a node insertion measure to obtain a floating display area, and then executing a floating item configuration measure in the display area of the home page; monitoring a control action of a control device in the display area of the home page, and performing an information windowing measure to obtain floating webpages; and monitoring the number of floating webpages, monitoring the control action of the control device in the floating display area, and then performing an action feedback measure. The present method may obtain the floating display area by means of initialization in different browsers, feed back mouse click actions of a user on a floating page by means of different measures, and display content of any type by means of the floating page in a floating manner, thereby greatly increasing the efficiency with which a browser processes multiple tasks.

This application claims the priority of the Chinese patent application filed on Dec. 20, 2020 before the CNIPA, China National Intellectual Property Administration with the application number of 202011512796.0 and the title of “WEBPAGE DISPLAY METHOD, SYSTEM AND MEDIUM”, which is incorporated herein in its entirety by reference.

### FIELD

The present application relates to the technical field of Internet, in particular to a web page display method, a medium and a computing and processing device.

### BACKGROUND

When users use the browser to process some online tasks and online work on the network, it is inevitable that there will be too many tasks or work, or that multiple window processes need to be opened for simultaneous processing when processing tasks and work. At this time, the multi-window suspension parallel processing function of the browser is particularly important. Existing browsers need to download the corresponding plug-in to achieve multi-window suspension, the steps are more cumbersome, and the major browser vendors are different, their kernel versions are different, plug-ins may not adapt to multiple types of browsers at the same time; on the basis of this problem, the mobile browser may realize the window suspension operation of any browser through the download of web widgets, but the displayed web page is only limited to the content of videos, pictures and advertisements.

### SUMMARY

The present application mainly solves the problem that the page suspension function in the browser is cumbersome, restrictive and too limited when using the browser.

In order to solve the above-mentioned technical problems, the present application adopts a technical solution that: providing a web page display method, including:
monitoring a loading condition of a display area of a main page, executing node insertion measures to obtain a floating display area, and executing floating item configuration measures in the display area of the main page;
monitoring control actions of a control device in the display area of the main page, and executing information windowing measures to obtain floating web pages; and
monitoring a quantity of the floating web pages, monitoring control actions of a control device in the floating display area, and executing action feedback measures.

In some embodiments of the present application, the operation of monitoring the loading condition of the display area of the main page, executing the node insertion measures to obtain the floating display area, and executing the floating item configuration measure in the display area of the main page includes:
monitoring whether there is loading content in the display area of the main page, on the condition that there is the loading content in the display area of the main page, determining that the loading condition is that the display area of main page is loaded, and executing the node insertion measures; and
after executing the node insertion measures, executing the floating item configuration measures;
the node inserting measures are: inserting a content Dom node in the Dom root node of the loading content to obtain the floating display area; setting a resolution threshold value, obtaining resolution data of the browser, comparing the resolution data and the resolution threshold value, and setting a size of the floating display area according to a comparison result; and
the floating item configuration measures are: obtaining a floating support flag bit and a URL of the loaded content, inserting a floating flag bit in the floating support flag bit, saving the URL to the floating flag bit, and setting a floating click feedback area on the floating flag bit.

In some embodiments of the present application, the operation of monitoring the control actions of the control device in the display area of the main page and executing the information windowing measures to obtain the floating web page includes:
monitoring the control actions of the control device according to the floating click feedback area;
when the control action of the control device in the floating click feedback area is a click action, executing loading measures on the URL in the floating flag bit corresponding to the floating click feedback area to obtain a floating sub-node corresponding to the URL;
executing determination measures on the URL after executing the loading measures, and determining whether to execute the information windowing measures on the floating sub-node corresponding to the URL according to the determination measures; and
obtaining the floating web page corresponding to the floating sub-node after executing the information windowing measures on the floating sub-node.

In some embodiments of the present application, the loading measures are:
inserting a sub-node corresponding to the URL into the content Dom node of the loaded content to obtain the floating sub-node corresponding to the URL; and
the determination measures are:
obtaining a resource file of the URL and determining whether the resource file is a real-time file, on the condition that the resource file is a real-time file, executing the information windowing measures on the floating sub-node corresponding to the URL; on the condition that the resource file is not a real-time file, querying whether there is a cache file matching the resource file in a local cache of the browser; on the condition that there is no cache file matching with the resource file in the local cache of the browser, executing the information windowing measures on the floating sub-node corresponding to the URL.

In some embodiments of the present application, the information windowing measures are:
inserting a bearing tag corresponding to the floating sub-node into the floating sub-node, accessing the URL corresponding to the floating sub-nodes according to the bearing tag, obtaining floating web page content corresponding to the floating sub-node and loading the floating web page content to obtain the floating web page, and outputting the floating web page in the floating display area; and
setting an update time period, after outputting the floating web page, accessing the URL corresponding to the floating web page according to the bearing tag at intervals of the update time period, obtaining updated floating web page content corresponding to the floating web page, and updating the updated floating web page content to the floating web page.

In some embodiments of the present application, the method further includes: after executing the information windowing measures, assigning a corresponding ID and key to the floating web page, identifying the floating web page content corresponding to the floating web page according to the ID, and determining a position of the floating sub-node corresponding to the floating web page in the content Dom node according to the key.

In some embodiments of the present application, the operation of monitoring the quantity of the floating web pages, monitoring the control actions of the control device in the floating display area, and executing the action feedback measures includes:
the action feedback measures include: magnifying measures, closing measures, stacking measures and unfolding measures;
setting a quantity threshold value, setting a closing click feedback area, a magnifying click feedback area and a stacking movement feedback area on a bearing tag, and monitoring the quantity of floating pages;
when the quantity of the floating pages is less than the quantity threshold value, monitoring the control action of the control device according to the closing click feedback area, and executing the corresponding closing measures, at the same time, monitoring the control action of the control device according to the magnifying click feedback area and executing the corresponding magnifying measures; and
when the quantity of the floating pages is greater than the quantity threshold value, monitoring the control action of the control device according to the stacking movement feedback area, and executing the corresponding stacking measures and unfolding measures.

In some embodiments of the present application, the operation of monitoring the control actions of the control device according to the closing click feedback area and executing the corresponding closing measures includes:
querying the key of the floating page corresponding to the bearing tag corresponding to the closing click feedback area in the floating display area when the control action of the control device in the closing click feedback area is a click action, determining the position of the floating sub-node corresponding to the key in the content Dom node, deleting the floating sub-node in the content Dom node according to the position, and deleting the ID of the floating page and the bearing tag from the floating display area;
the operation of monitoring the control action of the control device according to the amplification click feedback area and executing the corresponding amplification measures includes:
collecting a URL corresponding to the loaded content in the display area of the main page when the control action of the control device in the magnifying click feedback area is the click action, and executing the loading measures on the URL to obtain the floating sub-node corresponding to the URL;
executing the determination measures on the URL after executing the loading measures, and determining whether to execute a corresponding information windowing measure on the floating sub-node according to the determination measures; and
accessing the URL of the floating page corresponding to the bearing tag according to the bearing tag corresponding to the magnifying click feedback area, outputting the floating page content corresponding to the URL in the display area of the main page, and executing the closing measures for the floating page in the floating display area;
the operation of monitoring the control action of the control device according to the stacking movement feedback area and executing the corresponding stacking measures and unfolding measures includes:
when the control action of the monitoring control device of the stacking movement feedback area is a moving-in action, executing the unfolding measures, and the unfolding measures are: selecting any one of the floating pages corresponding to the bearing tag corresponding to the stacking movement feedback area as a first-place arrangement floating page, and sequentially arranging and outputting the floating pages in the floating display area relative to the first-place arrangement floating page up and down; and
when the control action of the control device in the stacking movement feedback area is a move-out action, executing the stacking measures, and the stacking measures are: detecting the key of the floating page corresponding to the bearing tag corresponding to the stacking movement feedback area, setting a stacking rule, selecting a first stacked floating page in the floating pages according to the stacking rule and the key of the floating page, and arranging and outputting the floating pages in the floating display area relative to the first stacked floating page in front and back.

The present application further provides a web page display system, including: a main page display area module, a floating display area module, and a floating operation module;
the main page display area module is configured for monitoring a loading condition of a display area of a main page, executing node insertion measures to the display area of the main page according to the loading condition to obtain a floating display area, and executing floating item configuration measures in the display area of the main page; and
the floating display area module is configured for monitoring the control actions of the control device in the display area of the main page, and executing the corresponding information windowing measures according to the control actions to obtain floating web pages; and
the floating operation module is configured for monitoring a quantity of the floating web pages, monitoring control actions of the control device in the floating display area according to the quantity of the floating web pages, and executing the corresponding action feedback measures according to the control actions.

A non-transitory computer-readable storage medium, a computer program is stored on the computer-readable storage medium and the operations of the web page display method are implemented when the computer program is executed by a processor.

The present application has the beneficial effects that:

1. The web page display method described in the present application may realize that, in different browsers, the floating display area is obtained through initialization, the clicking action of the user's mouse is fed back on the floating page through different measures, and for any type of content, the floating display is carried out through the floating page, which greatly improves the efficiency of the browser in processing multitasks.

2. The web page display system described in the present application may realize that, a floating display area is obtained by initializing in the browser by the main page display area module, different measures are implemented through the floating operation module to feed back the clicking action of the user's mouse on the floating page, and any type of content is floated through the floating page by the floating display area module, which greatly improves the efficiency of the browser in processing multitasks.

3. The non-transitory computer-readable storage medium described in the present application may realize to guide the mutual cooperation between the main page display area module, the floating operation module and the floating display area module, and improve the operability of the web page display method.

### BRIEF DESCRIPTION OF THE DRAWINGS

FIG. 1 is a flow chart of a web page display method according to some embodiments of the present application;

FIG. 2 is a schematic diagram of a correspondence table between the size of the floating display area and the resolution size of the browser according to some embodiments of the present application;

FIG. 3 is a schematic diagram showing the effect of the web page display method according to some embodiments of the present application;

FIG. 4 is a schematic diagram showing the effect of the unfolding measures in the web page display method according to some embodiments of the present application;

FIG. 5 is a schematic diagram showing the effect of a floating window in the web page display method according to some embodiments of the present application;

FIG. 6 is a schematic structural diagram of the web page display system described in some embodiments of the present application; and

FIG. 7 schematically shows a block diagram of a computing and processing device for implementing the method according to the present application; and

FIG. 8 schematically shows a storage unit for maintaining or carrying a program code for implementing the method according to the present application.

### DETAILED DESCRIPTION

The embodiments of the present application will be described in detail below in conjunction with the drawings, so that the advantages and features of the present application may be more easily understood by those skilled in the art, so as to more clearly define the scope of protection of the present application.

In the description of the present application, it should be noted that Dom (Document Object Model) is a platform and language-independent application program interface, <float-page> </float-page> is a browser setting instruction, document.body.clientHeight is a height of a visible area of the browser, document.body.clientWidth is a width of the visible area of the browser, JavaScript is a just-in-time compilation type of high-level programming language, URL (uniform resource locato) is a representation method for specifying information locations on the World Wide Web service program of the Internet, iframe is an HTML tag, http is a simple request-response protocol, ID (Identity Document) is the identification number, key is the registry file, mouseover is the action of the mouse pointing to move into an element, mouseout is the action of the mouse pointing to move out an element, Web (World Wide Web) is the global wide area network, and clientHeight is the window height.

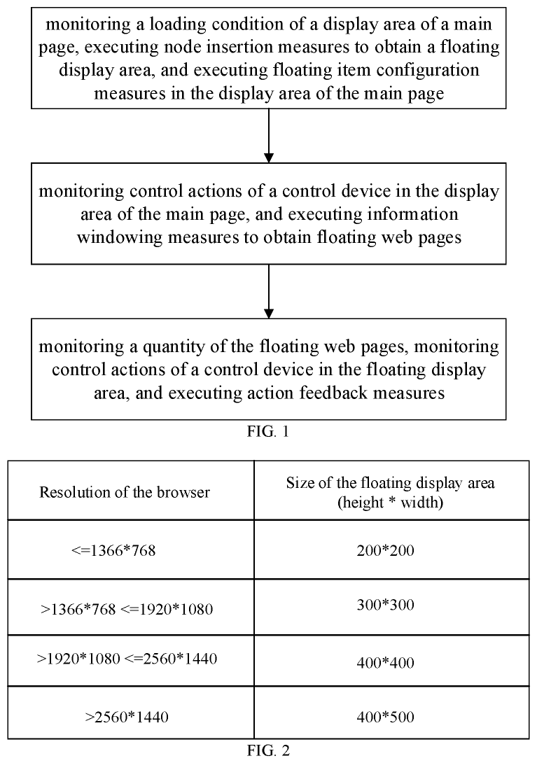

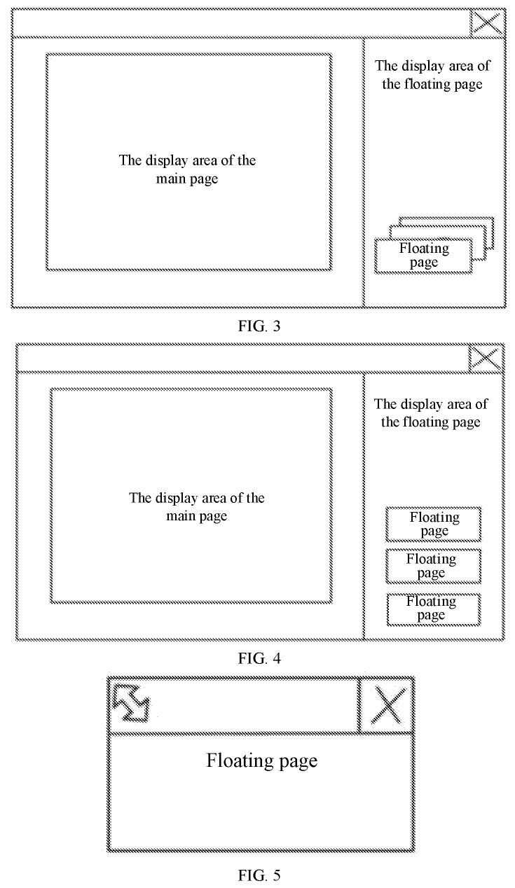

The present embodiment provides a web page display method, as shown in FIGS. 1 to 5, including the following operations:

S100. after the web page is opened, inserting a content Dom node <float-page> </float-page> in the root node of the Dom node of the web page; and regarding the content Dom node as the floating display area of the web page; the area of the whole web page except for the floating display area is the display area of the main page; the display area of the main page and the floating display area co-exist in the entire browser, which may be applied to any type of browsers, without the need to download the corresponding plug-in;

S200, setting the size of the floating display area; setting a low resolution threshold value, a medium resolution threshold value and a high resolution threshold value; capturing to obtain the document.body.clientHeight (i.e., the resolution data of the browser) and document.body.clientWidth (i.e., the resolution data of the browser) of the browser to identify the resolution size of the browser. On the condition that the resolution size of the browser is within the low resolution threshold value, adjusting the size of the floating display area to a low resolution size; on the condition that the resolution size of the browser is greater than the low resolution threshold value and less than the medium resolution threshold value, adjusting the size of the floating display area to a medium resolution size; on the condition that the resolution size of the browser is greater than the medium resolution threshold value and less than the high resolution threshold value, adjusting the size of the floating display area to a high resolution size. The table of the corresponding relationship between the size of the floating display area and the resolution of the browser is shown in FIG. 2:
among them, the display area of the main page and the floating display area share the inherent resources of the local cache of the browser, such as public pictures, public JavaScript dependent files and other static resources, which reduces the resource utilization rate of the computer system.

S300. acquiring a floating support flag bit of the loaded content in the display area of the main page when there is the loaded content in the display area of the main page; respectively inserting the floating flag bits into each floating support flag bit; saving the URL corresponding to the loaded content with the floating support flag bit in the corresponding floating flag bit; setting the floating click feedback area of the floating flag bit and monitor the control action of the mouse (i.e., control device);

S400. when the click action of the mouse is detected in the floating click feedback area of the floating flag bit, executing the loading measures: adding a floating sub-node of the URL of the loaded content corresponding to the floating flag bit in the content Dom node of the floating display area, and then executing the determination measures: obtaining a resource file corresponding to the URL information and determining whether the resource file is a real-time file; on the condition that the resource file is the real-time file, executing the information windowing measures on the floating sub-node corresponding to the URL; on the condition that the resource file is not the real-time file, querying the local cache directory of the browser and determining whether there is a cache file matching the resource file in the directory; on the condition that there is the cache file matching with the resource file in the directory, not loading the file and reading the cache file in the local cache directly; on the condition that there is no cache file matching the resource files in the directory, executing the information windowing measures on the floating sub-node corresponding to the URL;
the information windowing measures are:
inserting an iframe tag (i.e., a bearing tag) corresponding to the URL information on the floating sub-node, sending an http request to the server at the URL end according to the iframe tag, obtaining and loading the floating web page content corresponding to the URL information to obtain the floating web page;
setting an update time period, accessing the URL of the floating web page at intervals of the update time period, updating the content of the floating web page corresponding to the floating web page according to the URL, and outputting the content of the floating web page in the floating display area;
assigning an ID and a key to the floating page; the ID is used to identify the content of the floating web page; the content of the ID is associated with the content of the floating web page; and the key is used to identify the position information of the floating sub-node.

On the condition that the cache file is read before executing the information windowing measures, the web page content corresponding to the cache file is loaded as the floating web page content.

The ID of the floating web page is displayed in the floating window. After a plurality of floating web pages are generated, there will be a plurality of floating windows in the floating display area. Action feedback measures may be performed on the floating windows through the control operation of the mouse.

S500. executing the action feedback measures;
the action feedback measures are:
setting the closing click feedback area and the magnifying click feedback area on the bearing tag corresponding to the floating page;
monitoring the quantity of the floating pages. When there is only one floating page, the closing the click feedback area and the magnifying click feedback area are in the sensing state. When the mouse clicks in the closing click feedback area, executing the closing measures to close the floating page. When the control device clicks in the magnifying click feedback area, performing the magnifying measures to the floating sub-window. In actual operation, the display forms of the closing click feedback area and the magnifying click feedback area are a close button and a magnifying button.

The magnifying measures are: collecting the URL of the content in the display area of the main page, performing operations of S400 on the URL of the display area of the main page, accessing the URL of the floating page, and outputting the content corresponding to the URL in the display area of the main page; querying the key corresponding to the floating page in the floating display area, determining the floating sub-node corresponding to the key, and deleting the floating sub-node from the content Dom; deleting the ID and label of the floating page from the floating display area, and does not affect the display of the floating page content of other floating pages.

Setting the stacking movement feedback area on the bearing tag corresponding to the floating page, monitoring the movement behavior of the mouse. When the mouse generates a mouseover event (i.e., move-in action) in the movement feedback area, that is, when the mouse moves to a certain floating window, performing the unfolding measures: setting the height of the floating display area to clientHeight of the browser, determining a floating page to be a first-place arrangement floating page, and arranging and displaying all the floating pages up and down relative to the first-place arrangement floating page. Detecting whether the arrangement size of the floating pages exceeds the height of the browser. On the condition that the arrangement size of the floating pages exceeds the height of the browser, adding a scroll bar to the floating display area, and moving the floating pages by the scroll bar; when the mouseout event (i.e., the move-out action) is in the floating movement feedback sensing area, that is, when the mouse is moved away from a certain floating window, executing the stacking measures: setting the height of the floating display area to be a default height, detecting the key value of the floating page, and setting the stacking rule. In the floating page, selecting the first stacked floating page according to the stacking rule and the key value of the floating page, in detail: sorting the floating pages according to their key value from small to large, and regarding the first place floating page with the smallest key value as the first stacked floating page, and arranging the rest of the floating pages after the first stacked floating page in sequence, and only displaying the ID of the floating page;

S600, setting a display threshold value and a detection time period, detecting the quantity of the floating sub-windows at every detection time period, and sending an alarm signal when the quantity of the floating sub-windows is equal to the display threshold value; among them, the display threshold value may be modified according to the system configuration and the demand of users.

The method may be applied in the Web background management system to realize simultaneous operation and processing of multi task processes for log information and monitoring information and other contents.

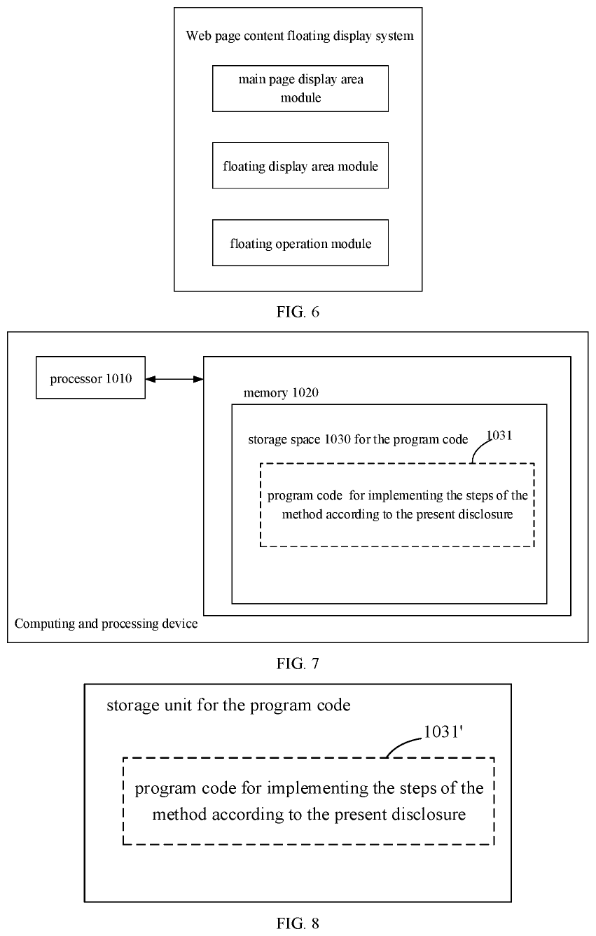

The present embodiment provides a web page display system, as shown in FIG. 6, including: a floating display area module, a main page display area module and a floating operation module;
the main page display area module includes a floating area initial module, a size setting module and a floating flag bit insertion module; a click feedback module is arranged on the floating flag bit insertion module;
the floating area initial module; when a web page is opened, the floating region initialization module inserts a content Dom node <float-page> </float-page> in the root node of the Dom node of the web page; and the content Dom node is regarded as the floating display area of the web page;
the size setting module; the size setting module is used for setting the size of the floating display area; a low resolution threshold value, a medium resolution threshold value and a high resolution threshold value are set on the size setting module; the size setting module captures document.body.clientHeight and document.body.clientWidth of the browser to identify the resolution size of the browser. On the condition that the resolution size of the browser is within the low resolution threshold value, adjusting the size of the floating display area to the low resolution size; on the condition that the resolution size of the browser is greater than the low resolution threshold value and less than the medium resolution threshold value, adjusting the size of the floating display area to the medium resolution size; on the condition that the resolution size of the browser is greater than the medium resolution threshold value and less than the high resolution threshold value, adjusting the size of the floating display area to the high resolution size;
the floating flag bit insertion module; when the main page is opened, the floating flag bit insertion module acquires the flag bit that may support floating of the web page content loaded in the content area of the main page; and respectively inserting the floating flag bits into the flag bits which may support the floating of each web page content; saving the content of the web page which is displayed floatingly and supported by the floating flag bit insertion module to the flag bit; a click feedback module is arranged on the flag bit; the click feedback module is provided with a floating click feedback area. When the user clicks on the content with a floating flag bit, the click feedback module will send the corresponding floating page acquisition signal to the floating display area module.

The floating display area module includes: a floating page acquisition module, a floating page insertion module, a floating loading module, a web page hosting module and an ID module.

The floating page acquisition module; when the floating page acquisition module receives the floating page acquisition signal, the floating page acquisition module acquires the URL of the corresponding page and sends the corresponding insertion signal to the floating page insertion module; and sends the URL to the floating loading module;
after receiving the signal, the floating page insertion module adds the floating sub-node in the content Dom node of the floating display area and sends a floating loading signal to the floating loading module;
after receiving the floating loading signal, the floating loading module analyzes the URL of the page, obtains the resource file corresponding to the URL, and determines whether the resource file is a real-time file. On the condition that the resource file is the real-time file, the URL is sent to the web page hosting module. On the condition that the resource file is not the real-time file, it queries the local cache directory of the browser and determines whether there is a file corresponding to the resource file in the directory. On the condition that there is the file in the directory corresponding to the resource file, the file is not loaded, and the file in the local cache is read directly. On the condition that there is no file corresponding to the resource files in the local cache, the URL is sent to the web page hosting module. The latest obtained resource file or the file in the local cache is sent to the web page hosting module after completing the above operations.

The web page hosting module; the web page hosting module acts on the content Dom node of the floating display area and is provided with an iframe tag. The web page hosting module bears the web page content displayed in the floating display area through the bearing tag, so that each floating page may run independently without conflicting with the main page. When receiving the above documents, the web page hosting module displays the content of the documents through the bearing tag. When receiving the URL, the web page hosting module obtains the corresponding web page content by sending an http request to the server at the URL end, visits the URL of the page, refreshes the page content in real time through the URL, and displays the page content in the floating display area;
and sends an ID allocation signal corresponding to the web page to the ID module; only the ID allocation module has the key of the ID allocation authority.

After receiving the ID allocation signal, the ID module assigns the ID to the corresponding page. This ID is used to identify the content of the corresponding web page; the length of ID has a data threshold value, and the ID module collects the information within the data threshold value in each web page as the ID.

The floating operation module includes: a closing click feedback module, a magnifying click feedback module, floating page stacking module and floating page quantity detection module.

The bearing tag of the page is provided with the closing click feedback module and the magnifying click feedback module, which are provided with corresponding closing click feedback areas and magnifying click feedback areas on the bearing tag of the page.

When the quantity of the floating pages is only one, the closing click feedback module and the magnifying click feedback module are in the induction state; when the mouse executes a click action in the closing click feedback area, the close click feedback module closes the floating page; when the mouse executes a click action in the magnifying click feedback area, the magnifying click feedback module magnifies the floating page; when the floating page is magnified, the replacement module collects the content of the main page and executes the information windowing measures on the main page; the display area of the main page displays the content of the floating page; the web page hosting module looks for the key of the page, determines the dom node according to the key, sends a deletion signal to the floating page insertion module, and the floating page insertion module deletes the sub-node of the node from the content dom; removes the ID and iframe tag of the floating page from the floating display area without affecting the content display of other floating pages.

The floating page stacking module; the stacking module is provided with a stacking movement feedback area. The stacking module listens to the mouse movement behavior. When the mouseover event of the mouse occurs in the movement feedback sensing area, the stacking module sends a display signal to the size setting module. The size setting module sets the height of the floating display area to clientHeight of the browser and displays all the floating web page sub-windows in an up-down arrangement. At this time, the stacking module detects whether the arrangement size of the sub-window exceeds the height of the browser. On the condition that the arrangement size of the sub-window exceeds the height of the browser, the stacking module adds a scroll bar in the floating display area to move the floating sub-windows through the scroll bar. When the mouseout event is in the floating movement feedback sensing area, the stacking module sends a stacking signal to the size setting module, which sets the height of the floating display area to the default height. The stacking module detects the key value of the window, and sorts the sub-windows according to their key values from small to large, and the first place sub-window with the smallest key value is used as the first display window, and the rest of the sub-windows are arranged after the first display window in sequence, and only the ID information of the window is displayed.

The floating page quantity detection module; it is provided with a display threshold value and a detection time period. The floating page quantity detection module detects the quantity of the floating pages at every detection time period. When the quantity of the floating pages is equal to the display threshold value, an alarm signal is sent to the main page display area module. The floating page quantity detection module may make corresponding modifications to the display threshold value according to the system configuration and the user demand.

Based on the same application concept as a web page display method in the foregoing embodiments, the embodiments of the present specification also provide a non-transitory computer-readable storage medium on which a computer program is stored, and the operations of the web page display method are implemented when the computer program is executed by a processor.

Different from the prior art, the web page display method, system and medium of the present application may realize that, in different browsers, initializing the corresponding floating display area, feeding back the clicking action of the user's mouse on the floating page through different measures, and performing the floating display of any type of content through the floating page, which greatly improves the efficiency of the browser in processing multitasks and improves the applicability of the browsers.

Based on the same application concept as a web page display method in the foregoing embodiments, the embodiments of the present specification also provide a computing and processing device, including: a memory in which a computer program executable on the processor is stored; and one or more processors, wherein when the computer program is executed by the one or more processors, the computing and processing device is configured to cause the processor to implement the operations of the web page display method.

The above-described device embodiments are merely illustrative, wherein the units that are described as separate components may or may not be physically separate, and the components that are displayed as units may or may not be physical units; in other words, they may be located at the same one location, and may also be distributed to a plurality of network units. Part or all of the modules may be selected according to the actual demands to realize the purposes of the solutions of the embodiments. A person skilled in the art can understand and implement the technical solutions without paying creative work.

Each component embodiment of the present application may be implemented by hardware, or by software modules that are operated on one or more processors, or by a combination thereof. A person skilled in the art should understand that some or all of the functions of some or all of the components of the calculating and processing device according to the embodiments of the present application may be implemented by using a microprocessor or a digital signal processor (DSP) in practice. The present application may also be implemented as apparatus or device programs (for example, computer programs and computer program products) for implementing part of or the whole of the method described herein. Such programs for implementing the present application may be stored in a computer-readable medium, or may be in the form of one or more signals. Such signals may be downloaded from an Internet website, or provided on a carrier signal, or provided in any other forms.

For example, FIG. 7 shows a computing and processing device that can implement the method according to the present application. The computing and processing device traditionally comprises a processor 1010 and a computer program product or computer-readable medium in the form of a memory 1020. The memory 1020 may be electronic memories such as flash memory, EEPROM (Electrically Erasable Programmable Read Only Memory), EPROM, hard disk or ROM. The memory 1020 has the storage space 1030 of the program code 1031 for implementing any steps of the above method. For example, the storage space 1031 for program code may contain program codes 1031 for individually implementing each of the steps of the above method. Those program codes may be read from one or more computer program products or be written into the one or more computer program products. Those computer program products include program code carriers such as hard disk, compact disk (CD), memory card or floppy disk as shown in FIG. 8. Such computer program products are usually portable or fixed storage units. The storage unit may have storage segments or storage spaces with similar arrangement to the memory 1020 of the computing and processing device in FIG. 7. The program codes may for example be compressed in a suitable form. Generally, the storage unit contains a computer-readable code 1031′, which can be read by a processor like 1010. When those codes are executed by the computing and processing device, the codes cause the computing and processing device to implement each of the steps of the method described above.

The above is only the embodiment of the present application, and does not limit the patent scope of the present application. Any equivalent structure or equivalent process transformation made by using the contents of the specification and drawings of the present application, or directly or indirectly applied in other related technical fields, are equally included in the patent protection scope of the present application.

1. A web page display method, applied to a browser, wherein the method comprises:
monitoring a loading condition of a display area of a main page, executing node insertion measures to obtain a floating display area, and executing floating item configuration measures in the display area of the main page;
monitoring control actions of a control device in the display area of the main page, and executing information windowing measures to obtain floating web pages; and
monitoring a quantity of the floating web pages, monitoring control actions of a control device in the floating display area, and executing action feedback measures.

2. The web page display method according to claim 1, wherein the operation of monitoring the loading condition of the display area of the main page, executing the node insertion measures to obtain the floating display area, and executing the floating item configuration measure in the display area of the main page comprises:
monitoring whether there is loading content in the display area of the main page, on the condition that there is the loading content in the display area of the main page, determining that the loading condition is that the display area of main page is loaded, and executing the node insertion measures; and
after executing the node insertion measures, executing the floating item configuration measures;
the node inserting measures are: inserting a content document object model (Dom) node in the Dom root node of the loading content to obtain the floating display area; setting a resolution threshold value, obtaining resolution data of the browser, comparing the resolution data and the resolution threshold value, and setting a size of the floating display area according to a comparison result; and
the floating item configuration measures are: obtaining a floating support flag bit and a uniform resource locato (URL) of the loaded content, inserting a floating flag bit in the floating support flag bit, saving the URL to the floating flag bit, and setting a floating click feedback area on the floating flag bit.

3. The web page display method according to claim 2, wherein the operation of monitoring the control actions of the control device in the display area of the main page and executing the information windowing measures to obtain the floating web page comprises:
monitoring the control actions of the control device according to the floating click feedback area;
when the control action of the control device in the floating click feedback area is a click action, executing loading measures on the URL in the floating flag bit corresponding to the floating click feedback area to obtain a floating sub-node corresponding to the URL;
executing determination measures on the URL after executing the loading measures, and determining whether to execute the information windowing measures on the floating sub-node corresponding to the URL according to the determination measures; and
obtaining the floating web page corresponding to the floating sub-node after executing the information windowing measures on the floating sub-node.

4. The web page display method according to claim 3, wherein
the loading measures are:
inserting a sub-node corresponding to the URL into the content Dom node of the loaded content to obtain the floating sub-node corresponding to the URL; and
the determination measures are:
obtaining a resource file of the URL and determining whether the resource file is a real-time file, on the condition that the resource file is a real-time file, executing the information windowing measures on the floating sub-node corresponding to the URL; on the condition that the resource file is not a real-time file, querying whether there is a cache file matching the resource file in a local cache of the browser; on the condition that there is no cache file matching with the resource file in the local cache of the browser, executing the information windowing measures on the floating sub-node corresponding to the URL.

5. The web page display method according to claim 3, wherein the information windowing measures are:
inserting a bearing tag corresponding to the floating sub-node into the floating sub-node, accessing the URL corresponding to the floating sub-nodes according to the bearing tag, obtaining floating web page content corresponding to the floating sub-node and loading the floating web page content to obtain the floating web page, and outputting the floating web page in the floating display area; and
setting an update time period, after outputting the floating web page, accessing the URL corresponding to the floating web page according to the bearing tag at intervals of the update time period, obtaining updated floating web page content corresponding to the floating web page, and updating the updated floating web page content to the floating web page.

6. The web page display method according to claim 4, wherein the method further comprises: after executing the information windowing measures, assigning a corresponding identity document (ID) and key to the floating web page, identifying the floating web page content corresponding to the floating web page according to the ID, and determining a position of the floating sub-node corresponding to the floating web page in the content Dom node according to the key.

7. The method for displaying web pages according to claim 6, wherein the operation of monitoring the quantity of the floating web pages, monitoring the control actions of the control device in the floating display area, and executing the action feedback measures comprises:
the action feedback measures comprise: magnifying measures, closing measures, stacking measures and unfolding measures;
setting a quantity threshold value, setting a closing click feedback area, a magnifying click feedback area and a stacking movement feedback area on a bearing tag, and monitoring the quantity of floating pages;
when the quantity of the floating pages is less than the quantity threshold value, monitoring the control action of the control device according to the closing click feedback area, and executing the corresponding closing measures, at the same time, monitoring the control action of the control device according to the magnifying click feedback area and executing the corresponding magnifying measures; and
when the quantity of the floating pages is greater than the quantity threshold value, monitoring the control action of the control device according to the stacking movement feedback area, and executing the corresponding stacking measures and unfolding measures.

8. The web page display method according to claim 7, wherein the operation of monitoring the control actions of the control device according to the closing click feedback area and executing the corresponding closing measures comprises:
querying the key of the floating page corresponding to the bearing tag corresponding to the closing click feedback area in the floating display area when the control action of the control device in the closing click feedback area is a click action, determining the position of the floating sub-node corresponding to the key in the content Dom node, deleting the floating sub-node in the content Dom node according to the position, and deleting the ID of the floating page and the bearing tag from the floating display area;
the operation of monitoring the control action of the control device according to the amplification click feedback area and executing the corresponding amplification measures comprises:
collecting a URL corresponding to the loaded content in the display area of the main page when the control action of the control device in the magnifying click feedback area is the click action, and executing the loading measures on the URL to obtain the floating sub-node corresponding to the URL;
executing the determination measures on the URL after executing the loading measures, and determining whether to execute a corresponding information windowing measure on the floating sub-node according to the determination measures; and
accessing the URL of the floating page corresponding to the bearing tag according to the bearing tag corresponding to the magnifying click feedback area, outputting the floating page content corresponding to the URL in the display area of the main page, and executing the closing measures for the floating page in the floating display area;
the operation of monitoring the control action of the control device according to the stacking movement feedback area and executing the corresponding stacking measures and unfolding measures comprises:
when the control action of the monitoring control device of the stacking movement feedback area is a moving-in action, executing the unfolding measures, and the unfolding measures are: selecting any one of the floating pages corresponding to the bearing tag corresponding to the stacking movement feedback area as a first-place arrangement floating page, and sequentially arranging and outputting the floating pages in the floating display area relative to the first-place arrangement floating page up and down; and
when the control action of the control device in the stacking movement feedback area is a move-out action, executing the stacking measures, and the stacking measures are: detecting the key of the floating page corresponding to the bearing tag corresponding to the stacking movement feedback area, setting a stacking rule, selecting a first stacked floating page in the floating pages according to the stacking rule and the key of the floating page, and arranging and outputting the floating pages in the floating display area relative to the first stacked floating page in front and back.

9. (canceled)

10. A non-transitory computer-readable storage medium, wherein a computer program is stored on the computer-readable storage medium and when the computer program is executed by a processor, causes the processor to:
monitor a loading condition of a display area of a main page, execute node insertion measures to the display area of the main page according to the loading condition to obtain a floating display area, and execute floating item configuration measures in the display area of the main page; and
monitor the control actions of the control device in the display area of the main page, and execute the corresponding information windowing measures according to the control actions to obtain floating web pages; and
monitor a quantity of the floating web pages, monitor control actions of the control device in the floating display area according to the quantity of the floating web pages, and execute the corresponding action feedback measures according to the control actions.

11. The web page display method according to claim 2, wherein the operation of setting a resolution threshold value comprises:
setting a low resolution threshold value, a medium resolution threshold value and a high resolution threshold value.

12. The web page display method according to claim 11, wherein the operations of comparing the resolution data and the resolution threshold value, and setting a size of the floating display area according to a comparison result comprises:
on the condition that a resolution size of the browser is within the low resolution threshold value, adjusting the size of the floating display area to a low resolution size;
on the condition that the resolution size of the browser is greater than the low resolution threshold value and less than the medium resolution threshold value, adjusting the size of the floating display area to a medium resolution size; and
on the condition that the resolution size of the browser is greater than the medium resolution threshold value and less than the high resolution threshold value, adjusting the size of the floating display area to a high resolution size.

13. The web page display method according to claim 4, wherein the determination measures further comprise:
on the condition that there is the cache file matching with the resource file in the local cache of the browser, not loading the resource file and reading the cache file in the local cache directly.

14. The web page display method according to claim 5, wherein the method further comprises:
on the condition that the cache file is read before executing the information windowing measures, loading web page content corresponding to the cache file as the floating web page content.

15. The web page display method according to claim 7, wherein display forms of the closing click feedback area and the magnifying click feedback area are a close button and a magnifying button, respectively.

16. The web page display method according to claim 8, wherein the method further comprises:
detecting whether an arrangement size of the floating pages exceeds a height of the browser; and
on the condition that the arrangement size of the floating pages exceeds the height of the browser, adding a scroll bar to the floating display area, and moving the floating pages by the scroll bar.

17. The web page display method according to claim 8, wherein the operations of setting a stacking rule, selecting a first stacked floating page in the floating pages according to the stacking rule and the key of the floating page, and arranging and outputting the floating pages in the floating display area relative to the first stacked floating page in front and back comprise:
sorting the floating pages according to key values from small to large, and regarding a first place floating page with the smallest key value as the first stacked floating page, arranging the rest of the floating pages after the first stacked floating page in sequence, and only displaying the ID of the floating page.

18. The web page display method according to claim 1, wherein the method further comprises:
setting a display threshold value and a detection time period, detecting a quantity of floating sub-windows at every detection time period, and sending an alarm signal when the quantity of the floating sub-windows is equal to the display threshold value.

19. The non-transitory computer-readable storage medium according to claim 10, wherein the operation of monitor the loading condition of the display area of the main page, execute the node insertion measures to obtain the floating display area, and execute the floating item configuration measure in the display area of the main page comprises:
monitoring whether there is loading content in the display area of the main page, on the condition that there is the loading content in the display area of the main page, determining that the loading condition is that the display area of main page is loaded, and executing the node insertion measures; and
after executing the node insertion measures, executing the floating item configuration measures;
the node inserting measures are: inserting a content document object model (Dom) node in the Dom root node of the loading content to obtain the floating display area; setting a resolution threshold value, obtaining resolution data of the browser, comparing the resolution data and the resolution threshold value, and setting a size of the floating display area according to a comparison result; and
the floating item configuration measures are: obtaining a floating support flag bit and a uniform resource locato (URL) of the loaded content, inserting a floating flag bit in the floating support flag bit, saving the URL to the floating flag bit, and setting a floating click feedback area on the floating flag bit.

20. A computing and processing device, comprising:
a memory in which a computer program executable on the processor is stored; and
one or more processors, wherein when the computer program is executed by the one or more processors, the computing and processing device is configured to cause the processor to:
monitor a loading condition of a display area of a main page, execute node insertion measures to the display area of the main page according to the loading condition to obtain a floating display area, and execute floating item configuration measures in the display area of the main page; and
monitor the control actions of the control device in the display area of the main page, and execute the corresponding information windowing measures according to the control actions to obtain floating web pages; and
monitor a quantity of the floating web pages, monitor control actions of the control device in the floating display area according to the quantity of the floating web pages, and execute the corresponding action feedback measures according to the control actions.

21. The computing and processing device according to claim 20, wherein the operation of monitor the loading condition of the display area of the main page, execute the node insertion measures to obtain the floating display area, and execute the floating item configuration measure in the display area of the main page comprises:
monitoring whether there is loading content in the display area of the main page, on the condition that there is the loading content in the display area of the main page, determining that the loading condition is that the display area of main page is loaded, and executing the node insertion measures; and
after executing the node insertion measures, executing the floating item configuration measures;
the node inserting measures are: inserting a content document object model (Dom) node in the Dom root node of the loading content to obtain the floating display area; setting a resolution threshold value, obtaining resolution data of the browser, comparing the resolution data and the resolution threshold value, and setting a size of the floating display area according to a comparison result; and
the floating item configuration measures are: obtaining a floating support flag bit and a uniform resource locato (URL) of the loaded content, inserting a floating flag bit in the floating support flag bit, saving the URL to the floating flag bit, and setting a floating click feedback area on the floating flag bit.
